(19) United States
(12) Patent Application Publication
(10) Pub. No.: US 2008/0240831 A1
(43) Pub. Date: Oct. 2, 2008

(54) KEYBOARD WITH ENHANCED IRRADIATION BRIGHTNESS

(75) Inventor: Chia-Yun Yang, Taoyuan County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., Taoyuan (TW)

(21) Appl. No.: 12/055,130

(22) Filed: Mar. 25, 2008

(30) Foreign Application Priority Data
Mar. 27, 2007 (TW) TW96204904

(51) Int. Cl. B41J 5/00

(52) U.S. Cl. 400/490

(57) ABSTRACT

A keyboard. A membrane circuit assembly is disposed on a base plate. A key base is disposed on the membrane circuit assembly and comprises a first metal conducting portion and a second metal conducting portion. The first and second metal conducting portions are connected to a power source. An activating body is movably connected to the key base and comprises a third metal conducting portion and a fourth metal conducting portion. The third and fourth metal conducting portions are detachably connected to the first and second metal conducting portions, respectively. A light-emitting element is disposed on the activating body and connected to the third and fourth metal conducting portions. A keycap is disposed on the light-emitting element and connected to the activating body. The keycap drives the activating body to move, enabling the third and fourth metal conducting portions to respectively connect to the first and second metal conducting portions.

### BACKGROUND OF THE INVENTION

1. Field of the Invention

The invention relates to a keyboard, and more particularly to a keyboard with enhanced irradiation brightness.

2. Description of the Related Art

Luminous keyboards are available in laptops or cellular phones for providing diversification of usage in different environments.

Referring to FIG. 1, a conventional luminous keyboard 2 comprises a base plate 21, a membrane circuit assembly 22, a resilient member 23, a keycap 24, a light source 25, and a light guide 26. The light guide 26 is disposed on the base plate 21 and membrane circuit assembly 22. The light source 25 is disposed between the membrane circuit assembly 22 and the light guide 26. Light from the light source 25 can be transmitted to the keycap 24 through the light guide 26, generating a luminous effect on the keycap 24.

Nevertheless, as the light guide 26 provides a complex profile, manufacture and formation thereof are difficult. Additionally, constrained by the construction of the light guide 26, the luminous keyboard 2 provides non-uniform irradiation on the central area of the keycap 24, adversely affecting the luminous effect on the keycap 24. Moreover, as the light source 25 continuously outputs light, overall power consumption of the luminous keyboard 2 cannot be reduced.

Hence, there is a need for a keyboard with simplified assembly, enhanced irradiation brightness, and reduced power consumption.

### BRIEF SUMMARY OF THE INVENTION

A detailed description is given in the following embodiments with reference to the accompanying drawings.

An exemplary embodiment of the invention provides a keyboard comprising a base plate, a membrane circuit assembly, a power source, a key base, an activating body, a light-emitting element, and a keycap. The membrane circuit assembly is disposed on the base plate. The key base is disposed on the membrane circuit assembly and comprises a first metal conducting portion and a second metal conducting portion. The first and second metal conducting portions oppose each other and are connected to the power source. The activating body is movably connected to the key base and comprises a third metal conducting portion and a fourth metal conducting portion. The third and fourth metal conducting portions oppose each other. The third metal conducting portion is detachably connected to the first metal conducting portion. The fourth metal conducting portion is detachably connected to the second metal conducting portion. The light-emitting element is disposed on the activating body and connected to the third and fourth metal conducting portions. The keycap is disposed on the light-emitting element and connected to the activating body. The keycap drives the activating body to move, enabling the third and fourth metal conducting portions of the activating body to respectively connect to the first and second metal conducting portions of the key base.

The keyboard further comprises a resilient element connected between the key base and the activating body.

The key base further comprises a recess in which the activating body is movably disposed.

The keyboard further comprises a resilient element disposed in the recess and connected between the key base and the activating body.

The first and second metal conducting portions are disposed in the recess.

The keyboard further comprises a connecting pillar connecting the keycap to the activating body.

The base plate comprises a positioning hole. The key base further comprises a positioning pillar positioned in the positioning hole via the membrane circuit assembly.

The keyboard further comprises an abutting element connected to the activating body and opposing the membrane circuit assembly. The abutting element abuts the membrane circuit assembly by movement of the activating body.

The power source is connected to the membrane circuit assembly.

The power source is connected to the base plate.

### BRIEF DESCRIPTION OF THE DRAWINGS

The invention can be more fully understood by reading the subsequent detailed description and examples with references made to the accompanying drawings, wherein:

FIG. 1 is a schematic partial cross section of a conventional luminous keyboard;

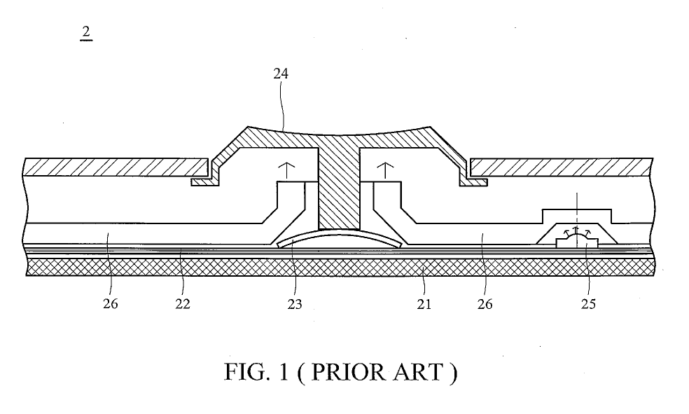

FIG. 2A is a schematic cross section of a keyboard of the invention in an operational mode;

FIG. 2B is a schematic cross section of the keyboard of the invention in another operational mode; and

FIG. 3 is a partial top view of the keyboard of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

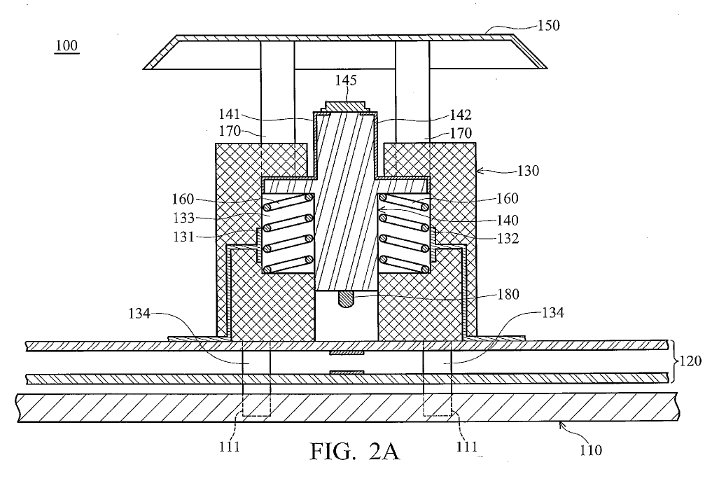

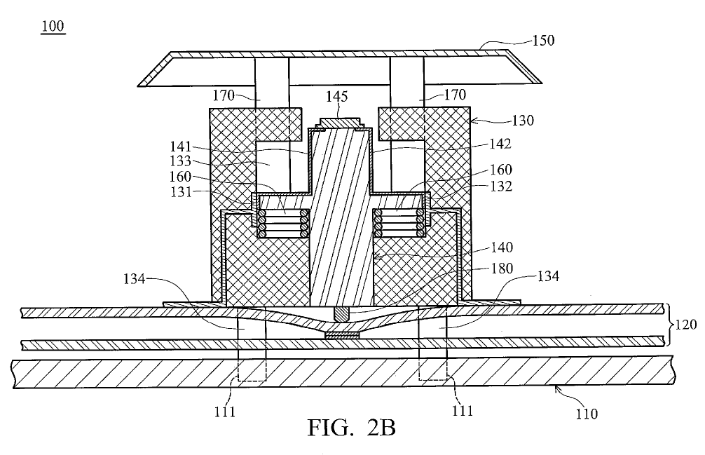

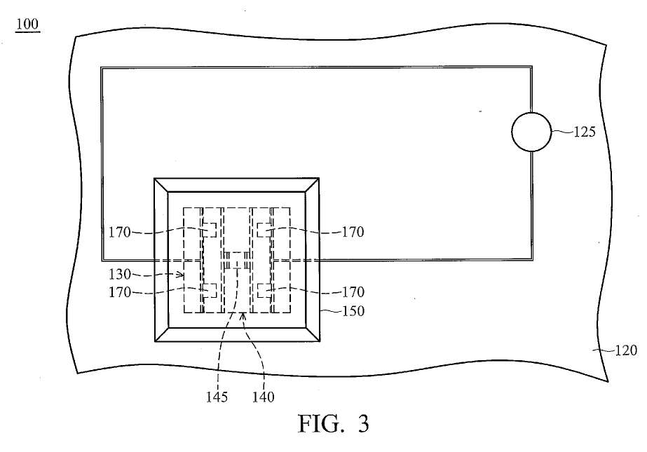

Referring to FIGS. 2A, 2B, and 3, a keyboard 100 may comprise a base plate 110, a membrane circuit assembly 120, a power source 125, a plurality of key bases 130, a plurality of activating bodies 140, a plurality of light-emitting elements 145, a plurality of keycaps 150, a plurality of resilient elements 160, a plurality of connecting pillars 170, and a plurality of abutting elements 180. Here, FIGS. 2A, 2B, and 3 show only a key base 130, an activating body 140, a light-emitting element 145, a keycap 150, and an abutting element 180 for descriptive brevity.

As shown in FIG. 2A and FIG. 2B, the base plate 110 comprises a plurality of positioning holes 111.

The membrane circuit assembly 120 is disposed on the base plate 110.

The power source 125 may be selectively connected to the membrane circuit assembly 120 or base plate 110. In this embodiment, the power source 125 is connected to the membrane circuit assembly 120, as shown in FIG. 3.

As shown in FIGS. 2A, 2B, and 3, each key base 130 is disposed on the membrane circuit assembly 120 and comprises a first metal conducting portion 131, a second metal conducting portion 132, a recess 133, and a plurality of positioning pillars 134. Each first metal conducting portion 131 and each second metal conducting portion 132 oppose each other and are connected to the power source 125. Specifically, each first metal conducting portion 131 and each second metal conducting portion 132 are disposed on two opposite inner walls in each recess 133 and are connected to a positive electrode and a negative electrode of the power source 125, respectively. Moreover, the positioning pillars 134 of the key base 130 are positioned in the positioning holes 111 of the base plate 110 via the membrane circuit assembly 120.

Each activating body 140 is movably connected to each key base 130. Specifically, each activating body 140 is movably disposed in the recess 133 of each key base 130 and comprises a third metal conducting portion 141 and a fourth metal conducting portion 142. The third metal conducting portion 141 and fourth metal conducting portion 142 oppose each other. Specifically, the third metal conducting portion 141 is detachably connected to the first metal conducting portion 131, and the fourth metal conducting portion 142 is detachably connected to the second metal conducting portion 132. Moreover, the first metal conducting portion 131, second metal conducting portion 132, third metal conducting portion 141, and fourth metal conducting portion 142 may be composed of copper.

Each light-emitting element 145 is disposed on each activating body 140 and connected to the third metal conducting portion 141 and fourth metal conducting portion 142 of each activating body 140. Moreover, the light-emitting element 145 may be a light-emitting diode (LED).

Each keycap 150 is disposed on each light-emitting element 145 and connected to each activating body 140. Specifically, each keycap 150 is connected to each activating body 140 through the connecting pillars 170. Namely, the connecting pillars 170 connect each keycap 150 to each activating body 140. Moreover, one or more transparent areas (not shown) may be formed on each keycap 150. The transparent areas may have profiles corresponding to specific symbols or characters.

As shown in FIG. 2A and FIG. 2B, the resilient elements 160 are disposed in the recess 133 of each key base 130 and connected between each key base 130 and each activating body 140. Moreover, the resilient elements 160 may be springs.

Each abutting element 180 is connected to (the bottom of) each activating body 140 and opposes the membrane circuit assembly 120, abutting the membrane circuit assembly 120 by movement of each activating body 140.

Accordingly, when pressed, the keycap 150 drives the corresponding activating body 140 to move toward the membrane circuit assembly 120. At this point, the third metal conducting portion 141 and fourth metal conducting portion 142 of the activating body 140 respectively connect to the first metal conducting portion 131 and second metal conducting portion 132 of the key base 130, and the abutting element 180 abuts the membrane circuit assembly 120. Here, the light-emitting element 145 irradiates by conduction of the first metal conducting portion 131, second metal conducting portion 132, third metal conducting portion 141, and fourth metal conducting portion 142, thereby clearly exhibiting the symbols or characters on the keycap 150. Additionally, the keyboard 100 outputs a corresponding signal when the abutting element 180 abuts the membrane circuit assembly 120.

In another aspect, when released, the keycap 150 returns to an original position by resilience provided by the resilient elements 160. At this point, the third metal conducting portion 141 and fourth metal conducting portion 142 of the activating body 140 are respectively disconnected from the first metal conducting portion 131 and second metal conducting portion 132 of the key base 130, terminating irradiation of the light-emitting element 145.

In conclusion, the disclosed keyboard can be easily assembled and provide enhanced irradiation brightness and reduced power consumption.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A keyboard, comprising:
a base plate;
a membrane circuit assembly disposed on the base plate;
a power source;
a key base disposed on the membrane circuit assembly and comprising a first metal conducting portion and a second metal conducting portion, wherein the first and second metal conducting portions oppose each other and are connected to the power source;
an activating body movably connected to the key base and comprising a third metal conducting portion and a fourth metal conducting portion, wherein the third and fourth metal conducting portions oppose each other, the third metal conducting portion is detachably connected to the first metal conducting portion, and the fourth metal conducting portion is detachably connected to the second metal conducting portion;
a light-emitting element disposed on the activating body and connected to the third and fourth metal conducting portions; and
a keycap disposed on the light-emitting element and connected to the activating body, wherein the keycap drives the activating body to move, enabling the third and fourth metal conducting portions of the activating body to respectively connect to the first and second metal conducting portions of the key base.

2. The keyboard as claimed in claim 1, further comprising a resilient element connected between the key base and the activating body.

3. The keyboard as claimed in claim 1, wherein the key base further comprises a recess in which the activating body is movably disposed.

4. The keyboard as claimed in claim 3, further comprising a resilient element disposed in the recess and connected between the key base and the activating body.

5. The keyboard as claimed in claim 3, wherein the first and second metal conducting portions are disposed in the recess.

6. The keyboard as claimed in claim 1, further comprising a connecting pillar connecting the keycap to the activating body.

7. The keyboard as claimed in claim 1, wherein the base plate comprises a positioning hole, and the key base further comprises a positioning pillar positioned in the positioning hole via the membrane circuit assembly.

8. The keyboard as claimed in claim 1, further comprising an abutting element connected to the activating body and opposing the membrane circuit assembly, wherein the abutting element abuts the membrane circuit assembly by movement of the activating body.

9. The keyboard as claimed in claim 1, wherein the power source is connected to the membrane circuit assembly.

10. The keyboard as claimed in claim 1, wherein the power source is connected to the base plate.
